(19) United States
(12) Patent Application Publication
(10) Pub. No.: US 2021/0298977 A1
(43) Pub. Date: Sep. 30, 2021

(54) INFECTIOUS DISEASE ISOLATION MODULE

(71) Applicant: Joshua McMahon, Samford (AU)

(72) Inventors: Joshua McMahon, Cedar Creek (AU); Gregory McMahon, Cedar Creek (AU)

(21) Appl. No.: 17/215,525

(22) Filed: Mar. 29, 2021

Related U.S. Application Data
(60) Provisional application No. 63/001,318, filed on Mar. 28, 2020.

(51) Int. Cl. A61G 10/00; A61G 10/02

(52) U.S. Cl. CPC A61G 10/005; A61G 10/02

(57) ABSTRACT

A disease isolation module for patients, where the module includes an inflatable body adapted to accommodate a bed for a patient, transparent walls on the inflatable body to enable observation of the patient, and a door on the inflatable body.

### CROSS-REFERENCE TO RELATED APPLICATIONS

This is a Nonprovisional U.S. patent application filed under 35 U.S.C. 111 and claiming priority to U.S. Provisional Application No. 63/001,318, filed Mar. 28, 2020.

### BACKGROUND OF THE INVENTION

### 1. Field of the Invention

The present invention relates to the medical industry and, more particularly to a means of minimizing the spread of infectious diseases in medical arenas.

### 2. Description of Related Art

The Covid-19 novel corona virus is highly contagious and presents a risk to patients and medical staff in hospitals. Patients are typically arranged on beds in wards with only curtains separating each patient. This creates an environment where each patient is exposed to the contagions of the neighbouring patients. It also makes the ward filled with contagions for medical staff. A major problem is that medical staff are becoming infected with the virus and are dying as a result.

So many people are contracting the corona virus that non-medical arenas (such as stadiums and office blocks) are being commandeered to function as make-shift hospitals. Although this temporarily solves the problem of creating space for medical treatment, it also infects the non-medical arena. Once the non-medical arena has served its purpose as a make-shift hospital, it will have to be returned to its former function. However, this exposes the people who move back into the arena to the risk of infection.

The object of the present invention is to provide a means of containing the spread of an infectious disease in a medical arena.

### SUMMARY OF THE INVENTION

According to the present invention there is provided a disease isolation module for patients, the module comprising:

(a) an inflatable body adapted to accommodate a bed for a patient;

(b) transparent walls on the inflatable body to enable observation of the patient; and

(c) a door on the inflatable body.

The advantage of the inflatable body is that can be rapidly erected with the aid of a pump. Time is of the essence when treating an influx of patients. The more quickly the patient can be isolated the less contagions are spread.

Preferably, module has one or more insertion portals. The insertion portals allow access to the interior of the module without entering the door. The insertion portals may, for example, allow a person to pass through power cables for any electronic equipment placed inside the module.

It is also preferred that the module has a high-efficiency particulate (‘hepa’) air filter machine. More preferably, the hepa air filter machine is placed outside the module and is connected to the module through an insertion portal.

It is also preferred that the module has an air conditioning unit. More preferably, the air conditioning unit is a split system with the air intake outside the module and the air outtake on the inside of the module. More preferably, the air intake is connected to the air outtake through an insertion portal.

It is preferred that the module has air vents. More preferably, the air vents are on the roof of the module. It is also preferred that the air vents have a filter.

The module may have an entry compartment and a bedroom compartment. The entry compartment can act as an air lock to help minimize the amount of contagions that can pass between the bedroom compartment of the module and the outside environment.

It is preferred that the door can be rolled up and affixed to allow the entry and exit of the bed. The door may have zips down each side. The door may be sealed at its base with the hook and loop fastener.

### BRIEF DESCRIPTION OF DRAWINGS

The patent or application file contains at least one drawing executed in color. Copies of this patent or patent application publication with color drawing(s) will be provided by the Office upon request and payment of the necessary fee.

Embodiments of the invention will be described with reference to the following drawings, in which:

FIG. 1 is perspective view of the left side of a disease isolation module according to an embodiment of the present invention.

FIG. 2 is perspective view of the front of the disease isolation module of FIG. 1.

FIG. 3 is perspective view of the right side of the disease isolation module of FIG. 1.

FIG. 4 is perspective closeup view of the seal on the door of the disease isolation module of FIG. 1.

FIG. 5 is a perspective view of the rear of the disease isolation module of FIG. 1.

FIG. 6 is a top perspective view of the disease isolation module of FIG. 1.

FIG. 7 is a perspective view of an embodiment of an insertion portal for use with the disease isolation module of FIG. 1.

### DETAILED DESCRIPTION OF THE INVENTION

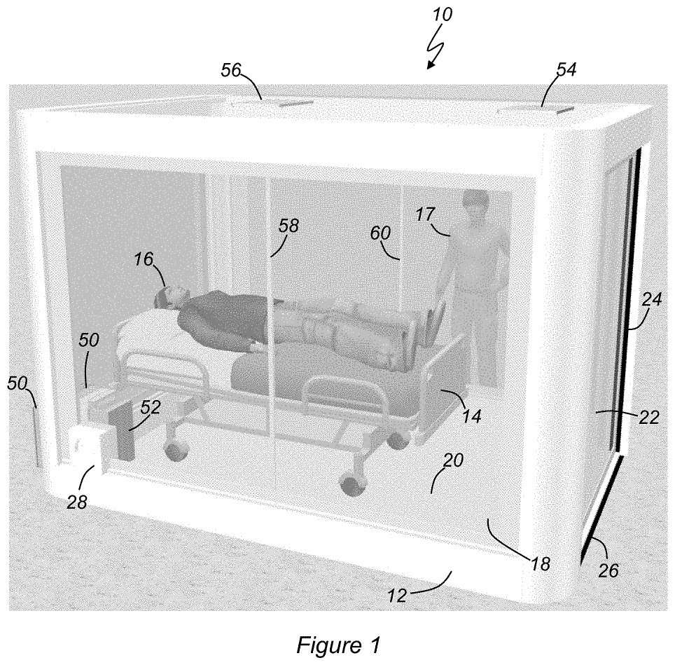

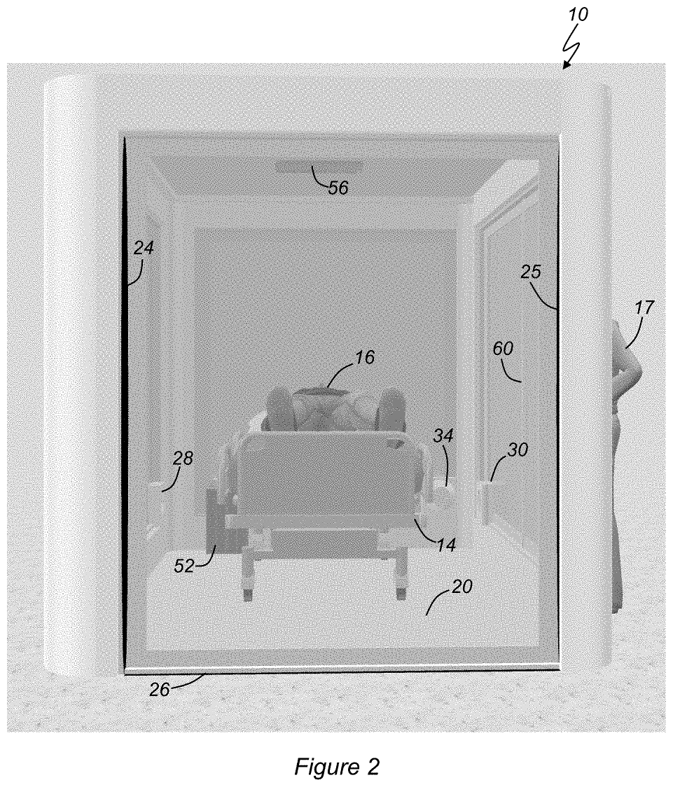

Referring to FIG. 1, the disease isolation module 10 has an inflatable body 12. An electric pump (not shown) is connected to a port (not shown) at the base of the body 12. The body can be erected using the pump in around one minute.

The ability of the module to be rapidly and easily deployed in emergency conditions during a pandemic outbreak provides a substantial contribution to the working of the invention. There is significant pressure on both ward staff and medical staff to quickly isolate infectious patients. The stress is such that it effects the mental health of the staff, aside from posing a risk to their life from the contagions. The present invention thereby helps hospital staff working on the front line of the war against the pandemic.

The size of the module is adapted to accommodate a bed 14 for a patient 16. Standard hospital beds have a sleep surface of 0.9144 meters (36 inches) in width and 2.032 meters (80 inches) in length. The overall measurements of a standard hospital bed are 0.9652 meters (38 inches) in width and 2.1336 meters (84 inches) in length (from the outside of the headboard to the footboard).

The outer dimension of a large module may be 3 meters (10 feet) in length by 2 meters (6 feet, 6 inches) in width, which provides an inner space of 2.7 meters (8 feet, 10 inches) in length by 1.7 meters (5 feet, 7 inches) in width. The outer dimension of a standard module may be 2.5 meters (8 feet, 2 inches) in length by 1.7 meters (5 feet, 7 inches) in width, which provides an inner space of 2.3 meters (7 feet, 6 inches) in length by 1.4 meters (4 feet, 7 inches) in width. Either model provides working space for equipment or staff alongside the bed within the module 10.

The module 10 has transparent walls 18 to enable medical staff 17 to observe the patient 16 from outside the module 10, thereby minimizing the spread of contagions. However, it should be noted that some clear polyvinyl chloride plastics can emit strong odours caused by toxic chemicals such as lead, phthalates, and volatile organic compounds. Therefore, it is preferred that a high-grade clear PVC plastic is selected which emits no odours. Alternatively, white polyester can also be used as side walls which do not emit odours. Another advantage of using white polyster is that it can provide the patient with a greater degree of privacy.

The module 10 also has an integral floor 20 which is joined to the walls 18. The integral floor 20 helps to prevent the spread of contagions from underneath the module 10 to the outside environment. The integral floor 20 also helps to prevent the spread of contagions onto the surface of the medical arena.

The floor 20 of the module 10 is the part of the module 10 which is most likely to become contaminated. On occasion, substances can be spilled on the floor 20. Therefore, the integral floor 20 is preferably joined to the side walls via hook and loop fasteners. This enables the floor to be removed and disposed between patients to promote a hygienic environment in the module 10.

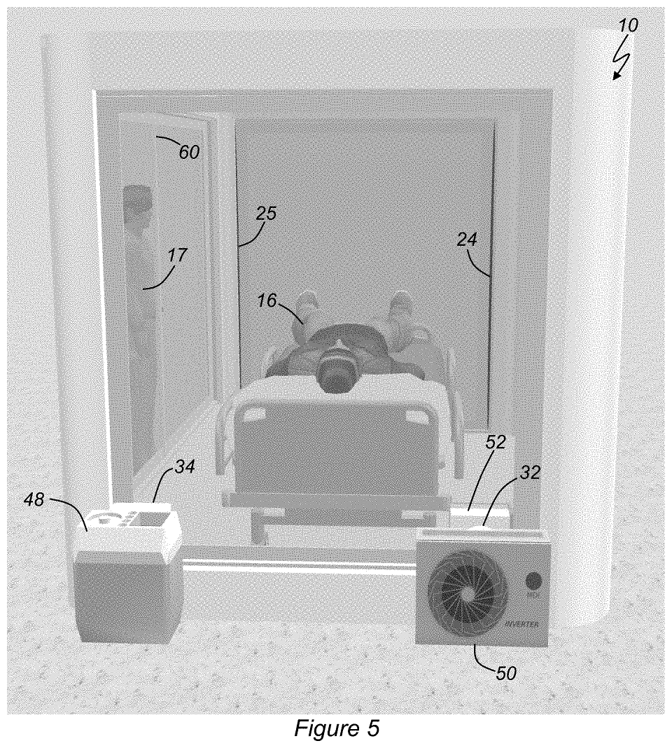

The module 10 has a door 22 with a zipper 24 on the left side and a zipper 25 on right side (refer to FIG. 5). The door 22 may be rolled up to allow the bed 14 to be wheeled in and out of the module 10. The door 22 can be rolled down and sealed with a hook and loop fastener (Velcro™) strap 26 (as shown in FIG. 4).

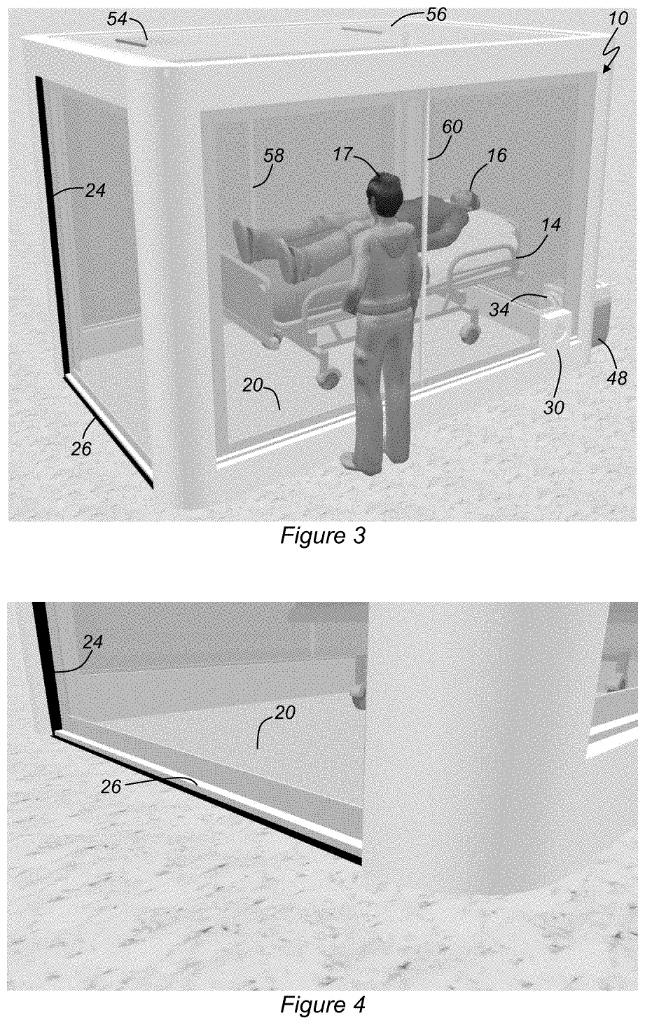

The module 10 has an insertion portal 28 on the left-hand side of the module 10 (shown in FIG. 1), an insertion portal 30 on right side of the module (shown in FIG. 3) and two insertion portals 32 and 34 on rear side of the module 10 (shown in FIG. 5). The insertion portals 28, 30, 32 and 34 allow access to the interior of the module 10 without entering the door 22. For example, the insertion portals 28, 30, 32 and 34 can be used to pass power cables for any electronic equipment placed inside the module 10.

An example of an insertion portal is shown in FIG. 7. This insertion portal 36 has a body 38 with a flap 40 that protects a circular passageway 42 that has a membrane 44 that closes around any object inserted through a central hole 46. Thereby, the insertion portal 36 helps to prevent the escape of any material, including viruses and bacteria from within the module 10. The flap 40 is spring-loaded in order to close over the body 38.

Alternatively, a PVC sock (of approximately 1.5 m in length) can be used as a portal. The sock has a string tie to close it, which gathers around any cables passing into the module 10.

The module 10 has an air extraction machine 48 (see FIG. 5) which has high-efficiency particulate (‘hepa’) air filter. The air extraction machine 48 is placed outside the module 10 and is connected to the module 10 through the insertion portal 34. The high-efficiency particulate (‘hepa’) air filter prevents contaminated air from escaping the module 10. The air extraction machine 48 creates a negative pressure within the module 10. It is important for the effective operation of the module 10 that the air etraction machine 48 is not set too high so that it causes the side walls of the module to become concaved.

The module 10 has an air conditioning system comprising an air intake 50 outside the module 10 and the air outtake 52 on the inside of the module 10. The air intake 50 is connected to the air outtake 52 through the insertion portal 32. The air intake 50 generates heat, so it needs to be outside the module 10 so as to avoid heating up the interior of the module 10. The air outtake 50 ensures that the air circulating within the module 10 remains at a comfortable temperature for the patient.

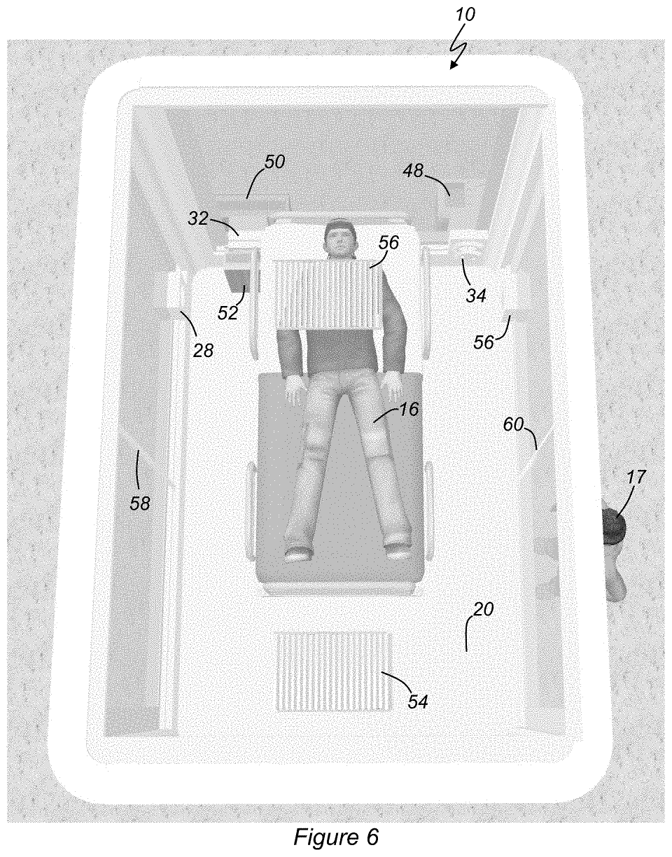

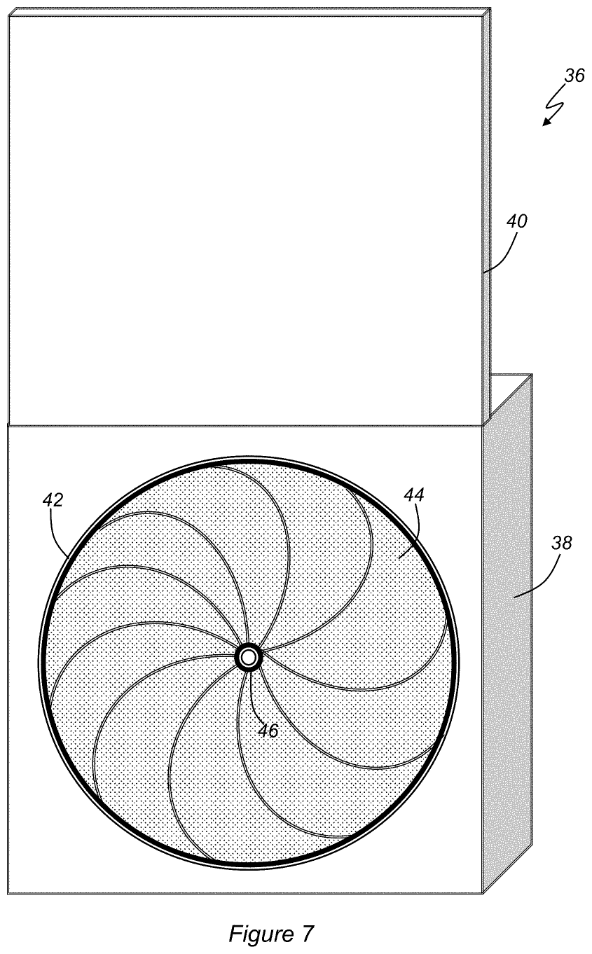

The module 10 has air vents 54 and 56 which have a filter (see FIG. 6). The air vents 54 and 56 are situated on the roof of the module 10 so that air flows across the patient. The air is drawn out of the module 10 using the air extraction machine 48, which has a hepa filter to capture contagions. The filtered vents 54 and 56 help to protect the patient 16 from contagions of other patients in the medical arena (e.g. the hospital), which may have different or more virulent strains of contagions.

The module 10 has a zipper 58 on its left side and a zipper 60 on its right side in order to allow medical staff to easily enter and exit from the module 10.

In some forms of the invention, the module has an entry compartment and a bedroom compartment. The entry compartment acts as an air lock to help minimize the amount of contagions that can pass between the bedroom compartment of the module and the outside environment.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A disease isolation module for patients, the module comprising:
(a) an inflatable body adapted to accommodate a bed for a patient;
(b) transparent walls on the inflatable body to enable observation of the patient; and
(c) a door on the inflatable body.

2. The module of claim 1, wherein the module has insertion portals.

3. The module of claim 1, wherein the module has a high-efficiency particulate air filter machine.

4. The module of claim 3, wherein the high-efficiency particulate air filter machine is on an air outtake.

5. The module of claim 1, wherein the module has an air conditioning unit.

6. The module of claim 5, wherein the air conditioning unit is a split system, and an air intake is on the outside of the module and an air outtake is on the inside of the module.

7. The module of claim 1, wherein the module has air vents.

8. The module of claim 7, wherein the air vents have a filter.

9. The module of claim 1, wherein the door can be rolled up.

10. The module of claim 1, wherein the door has zips.

11. The module of claim 1, wherein the door is sealed at its base with a hook and loop fastener.

12. The module of claim 1, wherein the module has an entry compartment and a bed compartment.
